(19) United States
(12) Patent Application Publication
(10) Pub. No.: US 2026/0118175 A1
(43) Pub. Date: Apr. 30, 2026

(54) RECONSTRUCTION METHOD FOR MULTI-INPUT SPECTRUM AND COMPUTATIONAL RECONSTRUCTION ON-CHIP SPECTROMETER

(71) Applicant: ZHEJIANG UNIVERSITY, Zhejiang (CN)

(72) Inventors: Daoxin DAI, Zhejiang (CN); Long ZHANG, Zhejiang (CN); Xiaowan SHEN, Zhejiang (CN)

(73) Assignee: ZHEJIANG UNIVERSITY, Zhejiang (CN)

(21) Appl. No.: 19/422,440

(22) Filed: Dec. 17, 2025

Related U.S. Application Data
(63) Continuation of application No. PCT/CN2024/118635, filed on Sep. 12, 2024.

(30) Foreign Application Priority Data
Aug. 6, 2024 (CN) 202411069818.9

(51) Int. Cl. G01J 3/02; G01J 3/28

(52) U.S. Cl. CPC G01J 3/0297; G01J 3/28; G01J 2003/283

(57) ABSTRACT

Disclosed are a reconstruction method for multi-input spectrum and a computational reconstruction on-chip spectrometer. The on-chip spectrometer adopted by the present disclosure has multiple input/output ports, with its core region being an arrayed waveguide containing thermal light tunable components, which may realize parallel detection for multiple spectra under test. Meanwhile, a reconstruction model is introduced to synchronously construct a mapping relationship between spectra under test and measured patterns under multi-port input, thereby realizing a spectrometer system for efficient parallel detection of multiple spectra under test. The present disclosure may realize a parallel detection with a high-resolution and a large-window for multiple spectra under test by means of a single spectrometer, thereby significantly improving detection efficiency.

### CROSS-REFERENCE TO RELATED APPLICATION

This application is a continuation of international application of PCT application serial no. PCT/CN2024/118635, filed on Sep. 12, 2024, which claims the priority benefit of China application no. 202411069818.9 filed on Aug. 6, 2024. The entirety of each of the above-mentioned patent applications is hereby incorporated by reference herein and made a part of this specification.

### TECHNICAL FIELD

The present disclosure relates to a reconstruction method for a spectrum, and particularly relates to a reconstruction method for a multi-input spectrum and a computational reconstruction on-chip spectrometer for implementing multispectral parallel detection.

### DESCRIPTION OF RELATED ART

As an important scientific research instrument, spectrometers have been extensively applied in various fields including agricultural detection, medical analysis, astronomical research, and optical coherence tomography imaging. Typically, in various application scenarios, it is necessary to achieve parallel detection of multiple spectral data while maintaining a high resolution and a large bandwidth.

For instance, in the aerospace sector, when conducting a large-scale spectroscopic detection using wide-field telescopes, it is necessary to divide the large aperture into multiple sub-fields of view and connect them in parallel with hundreds of spectrometer systems through optical fibers. The increase in the number of spectrometers brings a higher detection efficiency. Concurrently, it is imperative to maintain a high resolution to distinguish more subtle features, thereby revealing critical information regarding the nature and composition of celestial bodies. Additionally, a larger operational window is required to observe a greater number of celestial objects or more characteristics of the same celestial body.

However, there are bottlenecks for conventional spectrometer systems because of their bulky size and expensive components. Notably, multi-target detection technologies typically require array-based spectrometer systems, which exacerbates such bottlenecks. In recent years, while on-chip integrated spectrometers have gained significant attention due to their compact size and cost-effectiveness, they still rely on array stacking utilization of functional units. This is often constrained by large-scale optical systems, complex control circuits, and high costs. Furthermore, achieving a high resolution and a large bandwidth in current spectral parallel detection has proven to remain challenging. Therefore, providing a novel multi-spectral parallel detection architecture to achieve a high resolution, a large window, and a multi-spectral parallel detection within a single spectrometer is of paramount significance.

### SUMMARY

In view of the problems in the related art, the purpose of the present disclosure is to provide a computational reconstruction on-chip spectrometer that supports a high-resolution, a large-window, and a multi-spectral parallel detection. The present disclosure provides an on-chip spectrometer incorporating thermo-optic tunable components, wherein the spectrometer includes multiple input/output ports, and a core region enables parallel detection of multiple spectra under test. Simultaneously, a reconstruction method is introduced to synchronously establish mapping relationships between the spectra under test and measured patterns under multi-port input conditions, thereby achieving efficient parallel detection of multiple spectra under test. The present disclosure enables a parallel detection with a high-resolution and a large-window for multiple spectra under test by means of a single spectrometer, thereby significantly improving detection efficiency.

The technical solution adopted by the present disclosure is as follows:

### I. a Reconstruction Method for Multi-Input Spectrum

Step 1: Deploying thermal light tunable components in an arrayed waveguide region of an on-chip spectrometer, specifically deploying corresponding thermal light tunable components at each waveguide in the arrayed waveguide region, so that a phase distribution of light on each waveguide is tunable;
Step 2: Activating the thermal light tunable components randomly, then calibrating a calibration matrix of a current on-chip spectrometer;
Step 3: While maintaining the same random activation state as in step 2, inputting multiple spectra under test to the current on-chip spectrometer simultaneously, and the on-chip spectrometer outputs detection spectra;
Step 4: According to the calibration matrix and the detection spectra of the current on-chip spectrometer, after performing an optimization reconstruction on the multiple spectra under test respectively, multiple reconstructed spectra are obtained.

The reconstruction method further includes the following steps:
Step 5: If a precision of a current reconstructed spectrum does not reach a target precision, step 2 to step 4 are repeated to perform reconstruction on the spectrum again until a reconstructed spectrum with an optimal precision is obtained.

In the step 2, the step of calibrating the calibration matrix of the current on-chip spectrometer specifically involves the following process:

Inputting multiple known spectra to the current on-chip spectrometer, and measuring an output spectrum; calculating the calibration matrix of the current on-chip spectrometer according to the multiple known spectra and the corresponding output spectra.

In the step 4, an optimization target for a k-th spectrum under test is constructed, and optimization iteration is performed on the k-th spectrum under test according to a constructed optimization target, so that a reconstructed spectrum corresponding to the k-th spectrum under test is obtained after the optimization target is minimized. The formula of the optimization target for the k-th spectrum under test is specifically as follows:

$${\hat{s}}_{M \times 1 , k} = {min}_{{S}_{M \times 1 , k} , {S}_{M \times 1 , k} \geq 0} \{ {‖ {O}_{N \times 1} - {\sum }_{k = 1}^{k = K} {α}_{1 , k} \cdot {A}_{N \times M , k} \cdot {S}_{M \times 1 , k} ‖}^{2} + {\sum }_{k = 1}^{k = K} {α}_{2 , k} \vert \vert {S}_{M \times 1 , k} {\vert \vert}_{1} + {\sum }_{k = 1}^{k = K} {α}_{3 , k} \vert \vert D ( {S}_{M \times 1 , k} ) {\vert \vert}_{2}^{2} \}$$

In the formula, Ŝ_{M×1,k} is the reconstructed spectrum, O_{N×1} are the detection spectra, D( ) represents a differential operation, K is a quantity of spectra under test, α_{1,k}, α_{2,k} and α_{3,k} are a first weight to a third weight respectively; A_{N×M,k} is the calibration matrix of the k-th spectrum under test, S_{M×1,k} is the k-th spectrum under test, ∥ ∥₂ is a L2 norm; and ∥ ∥₁ is a L1 norm.

The thermal light tunable components include electrodes.

The precision of the reconstructed spectrum is specifically a relative reconstruction error εᵣ, and the calculation formula is as follows:

$${ε}_{r} = \frac{\vert \vert {S}_{M \times 1 , k} - {\hat{S}}_{M \times 1 , k} {\vert \vert}_{2}}{\vert \vert {S}_{M \times 1 , k} {\vert \vert}_{2}}$$

In the formula, S_{M×1,k} is the k-th spectrum under test, Ŝ_{M×1,k} is the reconstructed spectrum, and ∥ ∥₂ is the L2 norm.

The quantity of input waveguides of the on-chip spectrometer is greater than or equal to the quantity of the spectra under test.

### II. A Computational Reconstruction On-Chip Spectrometer for Multispectral Parallel Detection

The computational reconstruction on-chip spectrometer includes an on-chip spectrometer containing thermal light tunable components, a spectrometer calibration module, and a spectral optimization reconstruction module;

A spectrometer calibration module, configured to randomly activate thermal light tunable components and obtain a calibration matrix of a spectrometer in an activated state;

An on-chip spectrometer containing the thermal light tunable components, configured to generate detection spectra corresponding to multiple spectra under test;

A spectral optimization reconstruction module, configured to reconstruct the multiple spectra under test according to the calibration matrix and the detection spectra to obtain a reconstructed spectrum.

The computational reconstruction on-chip spectrometer further includes a spectral precision optimization module, the spectral precision optimization module is configured to calculate the precision of the reconstructed spectrum and optimize the reconstructed spectrum.

The advantageous effects of the present disclosure are as follows:

The present disclosure provides for the first time a waveguide-based multi-spectral parallel detection. For multi-port input spectrum, through the combination of on-chip spectrometer containing the thermal light tunable components and a reconstruction model, the configuration allows a larger operational window and improves the resolution of spectral detection. In addition, the present disclosure may implement simultaneous reconstruction of multiple spectra under test from multiple objects by a single spectrometer, thus greatly improving the efficiency of spectral detection.

### BRIEF DESCRIPTION OF THE DRAWINGS

FIG. 1 is a flowchart of a method in the present disclosure.

FIG. 2 is a schematic view of an architecture of the present disclosure.

FIG. 3 is a schematic view of a single random spectral response generation unit according to an embodiment of the present disclosure.

FIG. 4 is a schematic view of spectrum restoration for four-channel input spectra by the multi-spectral parallel detection spectrometer in an embodiment.

In the drawings: 1—input port, 2—single random spectral response generation unit, 3—output port, 4—input waveguide, 5—output waveguide, 6—first flat region, 7—arrayed waveguide region with heating electrodes, 8—second flat region.

### DESCRIPTION OF THE EMBODIMENTS

The present disclosure will be further described below in combination with the accompanying drawings and embodiments.

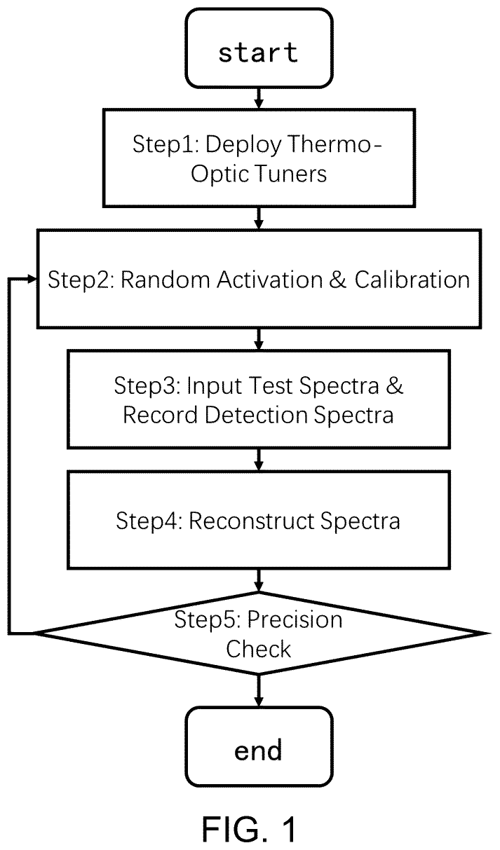

As shown in FIG. 1, the reconstruction method for multi-input spectrum provided by the present disclosure includes the following steps:
Step 1: Deploying electrodes in an arrayed waveguide region of an on-chip spectrometer, specifically deploying corresponding electrodes at each waveguide in the arrayed waveguide region, so that a phase distribution of light on each waveguide is tunable;
Step 2: In order to increase the randomness of the spectrum, activating the electrodes randomly, then calibrating the calibration matrix of the current on-chip spectrometer;

The step of calibrating the calibration matrix of the current on-chip spectrometer specifically involves the following process:

Inputting multiple known spectra to the current on-chip spectrometer, and measuring the output spectra; obtaining the calibration matrix of the current on-chip spectrometer according to the multiple known spectra and the corresponding output spectra.
Step 3: Activating the electrodes with the activation method in step 2, inputting multiple spectra under test to the current on-chip spectrometer through the multiple input waveguides of the on-chip spectrometer, and outputting the detection spectra in the output waveguides of the on-chip spectrometer; each output port of the on-chip spectrometer has one output spectral line (horizontal coordinate is wavelength, vertical coordinate is light power), all output ports finally compose a matrix (X-axis is port number, Y-axis is wavelength, Z-axis is light power), thereby obtaining the calibration matrix.
Step 4: According to the calibration matrix and the detection spectra, after performing the optimization reconstruction on multiple spectra under test respectively, multiple reconstructed spectra are obtained.

The optimized reconstruction in step 4 may be simply understood as using a mapping network within the spectrometer to establish a connection between a pattern under test and the spectrum array under test, where the mapping network is a three-dimensional matrix A. Mathematically, the detected signal O_{N} is represented as an integral of a spectral response matrix A of this architecture and an incident unknown spectrum array Sₖ(λ), namely:

$${\sum }_{k = 1}^{k = K} {\int }_{{λ}_{start}}^{{λ}_{stop}} {A}_{n , k} ( λ ) \cdot {S}_{k} ( λ ) d λ = {\sum }_{k = 1}^{k = K} {I}_{n , k} = {O}_{n} , \qquad ( n = 1 , … , N )$$

Here, λₛₜₐᵣₜ and λₛₜₒₚ are the start wavelength and cutoff wavelength of the operational band, respectively. A_{n,k}(λ) is the calibration matrix. Sₖ(λ) is the incident unknown multispectral array, K is the quantity of spectra under test, and k is an incident port sequence. I_{n,k} is a signal detected by all output channels after a single spectrum is input from a k-th channel. N represents the quantity of random module tuning states. Oₙ is the sum of signals detected by all output channels after multiple spectra are incident simultaneously, which is the actual detected optical power. Each layer Aₖ in the three-dimensional spectral response matrix represents the spectrum mapping under the input of a specific k-th port. After uniformly discretizing the unknown spectrum into M columns, the above formula may be rewritten as follows:

$${\sum }_{k = 1}^{k = K} {A}_{N \times M , k} \cdot {S}_{M \times 1 , k} = {\sum }_{k = 1}^{k = K} {I}_{N \times 1 , k} = {O}_{N \times 1}$$

In the formula, A_{N×M,K} is a three-dimensional matrix, representing a dependency relationship of the architecture spectral response on tuning state/wavelength/incident port sequence. Each row vector in Aₖ corresponds to a spectral response of a specific sampling step, while each column vector in Aₖ represents a temporal speckle of a single wavelength. Since the A_{N×M,K} matrix and ON 1 may be obtained through experimental measurement, a solution of S_{M×1,K} may be directly obtained.

However, in this case, the system is typically unconstrained or noisy, so converting the spectrum reconstruction problem into inverse matrix processing requires optimizing regularization techniques to specify a unique solution. Here it is assumed that the spectral values are positive and exhibit continuous smooth features, which is reasonable according to the properties of the spectrum.

To implement spectral reconstruction of multiple spectra with narrowband, broadband, and even complex features, a solver needs to be used to solve the current multispectral reconstruction problem. The present disclosure provides an objective function for the current multispectral reconstruction problem. For the optimized reconstruction of the k-th spectrum under test, the formula of the optimization target is as follows. According to the constructed optimization target, optimization iteration is performed on the k-th spectrum under test, so that after the optimization target is minimized, the reconstructed spectrum corresponding to the k-th spectrum under test is obtained:

$${\hat{s}}_{M \times 1 , k} = {min}_{{S}_{M \times 1 , k} , {S}_{M \times 1 , k} \geq 0} \{ {‖ {O}_{N \times 1} - {\sum }_{k = 1}^{k = K} {α}_{1 , k} \cdot {A}_{N \times M , k} \cdot {S}_{M \times 1 , k} ‖}^{2} + {\sum }_{k = 1}^{k = K} {α}_{2 , k} \vert \vert {S}_{M \times 1 , k} {\vert \vert}_{1} + {\sum }_{k = 1}^{k = K} {α}_{3 , k} \vert \vert D ( {S}_{M \times 1 , k} ) {\vert \vert}_{2}^{2} \}$$

In the formula, Ŝ_{M×1,k} is the reconstructed spectrum, O_{N×1} are the detection spectra, min_{SM×1,k,SM×1,k≥0} (⋅) is a global optimal value of the spectrum under test S_{M×1,k}, with minimum output power and non-negativity at k. The first term is used to minimize the difference between the detection spectra O_{N×1} and the sum of the calculated α_{1,k}·A_{N×M,k}·S_{M×1,k}, the second regularization term promotes the sparsity of the spectrum under test S_{M×1,k}, and the third differential regularization term smooths S_{M×1,k}. Here α_{1,k}, α_{2,k} and α_{3,k} are the weights of the corresponding terms, and a standard k-fold cross-validation technique is adopted to determine appropriate parameters α_{1,k}, α_{2,k} and α_{3,k}. D( ) represents a differential operation, K is the quantity of spectra under test, α_{1,k}, α_{2,k} and α_{3,k} are the first weight to third weight respectively; A_{N×M,k} is a calibration matrix of the k-th spectrum under test, S_{M×1,k} is the k-th spectrum under test, ∥ ∥₂ is the L2 norm, which is a square root of a sum of squares of vector elements; ∥ ∥₁ is the L1 norm, which refers to a sum of absolute values of each element in the vector.
Step 5: If a precision of the current reconstructed spectrum does not reach a target precision, step 2 to step 4 are repeated to perform reconstruction on the spectrum again until the reconstructed spectrum with an optimal precision is obtained. Experiments show that the more irregular the electrode activation, the higher the precision of the reconstructed spectrum.

The precision of the reconstructed spectrum is specifically the relative reconstruction error εᵣ, and the calculation formula is as follows:

$${ε}_{r} = \frac{\vert \vert {S}_{M \times 1 , k} - {\hat{S}}_{M \times 1 , k} {\vert \vert}_{2}}{\vert \vert {S}_{M \times 1 , k} {\vert \vert}_{2}}$$

In the formula, S_{M×1,k} is the k-th spectrum under test, S_{M×1,k} is the reconstructed spectrum, ∥ ∥₂ is the L2 norm, which is the square root of the sum of squares of the absolute values of vector elements.

The present disclosure further provides a computational reconstruction on-chip spectrometer for multispectral parallel detection, which includes an on-chip spectrometer containing electrodes, a spectrometer calibration module, and a spectral optimization reconstruction module. The parallel detection of spectrum refers to a technology that uses specially designed optical systems and detector arrays to synchronously acquire multiple spectral information from the same light source or different light sources during the process of spectral measurement or analysis.

A spectrometer calibration module, configured to randomly activate the electrodes and obtain the calibration matrix of the spectrometer in the activated state;

An on-chip spectrometer containing the electrodes, configured to generate detection spectra corresponding to multiple spectra under test;

A spectral optimization reconstruction module, configured to reconstruct multiple spectra under test according to the calibration matrix and the detection spectra to obtain the reconstructed spectrum.

The computational reconstruction on-chip spectrometer further includes a spectral precision optimization module. The spectral precision optimization module is configured to calculate the precision of the reconstructed spectrum and optimize the reconstructed spectrum.

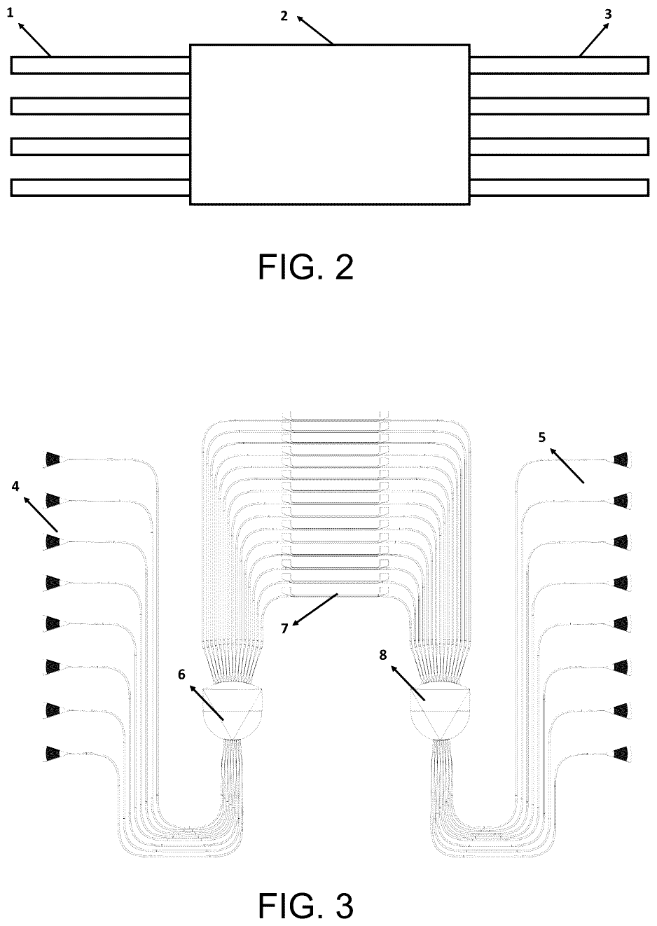

As shown in FIG. 2, the on-chip spectrometer provided by the present disclosure includes multiple input ports 1, a single random spectral response generation unit 2, and multiple output ports 3 connected in sequence.

FIG. 3 shows a single random spectral response generation unit of a specific embodiment. A core device thereof is a multi-port arrayed waveguide grating, composed of multiple input waveguides 4, multiple output waveguides 5, a first flat region 6, a second flat region 8, and an arrayed waveguide region 7 with electrodes. The waveguide length of the arrayed waveguide region 7 gradually increases with a constant difference ΔL. Each waveguide in the arrayed waveguide region 7 is deployed with a thermal light tunable portion of length Lt, which is the electrode. Specifically, input light of multiple spectra under test is input from multiple input waveguides 4. All input light undergoes diffraction when passing through the first flat region 6, different input spectra do not interfere with each other during diffraction, and the diffracted input light is then coupled into the arrayed waveguide region for transmission. Due to physical length differences, the arrayed waveguide region will change the phase distribution of light on each waveguide. In addition, by randomly activating a specific quantity of heating electrodes, the phase distribution may be further controlled freely. Then the output light emitted from each output position of the arrayed waveguide will undergo multi-beam interference in the second flat region 8, which will result in the formation of disordered patterns at the output waveguides along the flat region, which are the detection spectra. Finally, the reconstruction model is adopted to complete the restoration of multiple spectra under test.

Specific embodiments of the present disclosure are as follows:

Silicon nanowire optical waveguides based on a silicon-on-insulator material are selected. A core layer thereof is a silicon material Si with a thickness of 220 nm, and a shallow etch layer thickness thereof is 150 nm; a material for both a lower cladding and an upper cladding thereof is silicon dioxide SiO₂ with a thickness of 2 μm each. The key parameters of the arrayed waveguide grating in this embodiment are specifically shown in Table 1.

Table 1 shows the key parameters of the arrayed waveguide grating

| Parameter Name | Parameter Symbol | Parameter Value |
|---|---|---|
| Number of channels | N | 32 |
| Channel spacing | Δλ(nm) | 0.4 |
| Center wavelength | λ₀(μm) | 1.55 |
| Diffraction order | m | 80 |
| Length of free | L_{FPR} (μm) | 200 |
| propagation region | | |
| Spacing of array | d_{g} (μm) | 1.6 |
| waveguide | | |
| Quantity of array | N_{wg} | 81 |
| waveguide | | |
| Spacing of input- | dₒ (μm) | 1.84 |
| output waveguide | | |
| Difference in array | ΔL (μm) | 43.84 |
| waveguide length | | |
| Free spectral range | FSR (nm) | 14.6 |

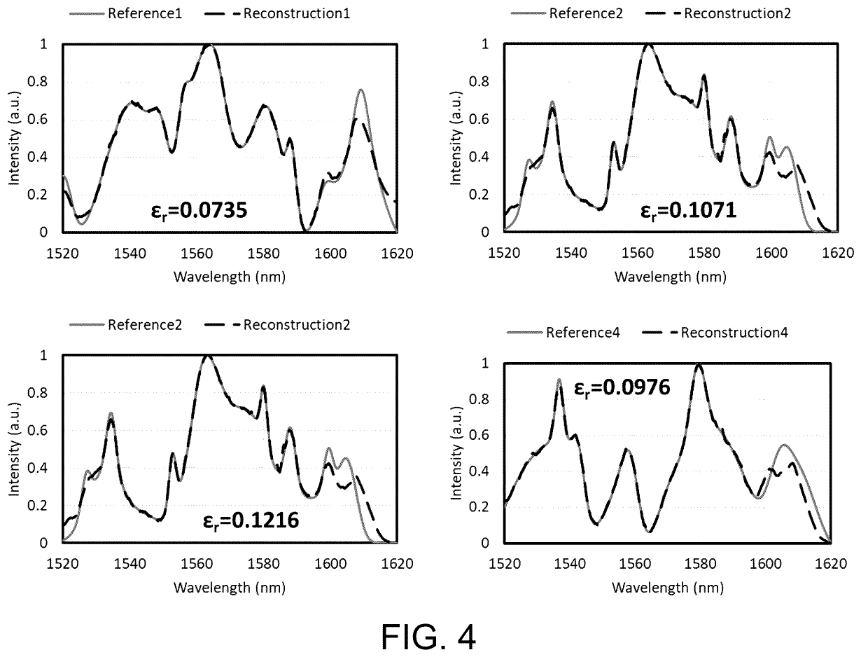

In this embodiment, first, 30 heating states are determined, and for each state, 30 heating electrodes are randomly selected and applied with a voltage of 3V. Each time, one input port is fixed, and 32 output spectra under 30 heating states are recorded respectively. There are 32 input ports in total. This serves as the matrix A of the random module. Subsequently, 4 input ports are randomly selected to simultaneously input test spectra, and the output power of 32 output ports is recorded. Spectral restoration is implemented through the computational reconstruction method to obtain 4 spectra under test. As shown in FIG. 4, this embodiment may simultaneously realize the restoration of 4 spectra under test, with an operational bandwidth reaching 100 nm, a resolution reaching 0.02 nm, and a relative reconstruction error <0.13.

The above embodiments are used to explain and illustrate the present disclosure, rather than to limit the present disclosure. Any modifications and changes made to the present disclosure within the spirit and scope to be protected by the claims of the present disclosure fall within the scope to be protected by the present disclosure.

What is claimed is:

1. A reconstruction method for multi-input spectrum, comprising the following steps:
step 1: deploying thermal light tunable components in an arrayed waveguide region of an on-chip spectrometer, specifically deploying the corresponding thermal light tunable components on each waveguide in the arrayed waveguide region, so that a phase distribution of light on each waveguide is tunable;
step 2: activating the thermal light tunable components randomly, then calibrating a calibration matrix of a current on-chip spectrometer;
step 3: while maintaining a same random activation state as in the step 2, inputting multiple spectra under test to the current on-chip spectrometer simultaneously, and outputting detection spectra to the on-chip spectrometer;
step 4: according to the calibration matrix and the detection spectra of the current on-chip spectrometer, after performing an optimization reconstruction on the multiple spectra under test respectively, obtaining multiple reconstructed spectra.

2. The reconstruction method for multi-input spectrum according to claim 1, wherein the reconstruction method further comprises the following steps:
step 5: if a precision of a current reconstructed spectrum does not reach a target precision, repeating the step 2 to step 4 to perform reconstruction on the spectrum again until a reconstructed spectrum with an optimal precision is obtained.

3. The reconstruction method for multi-input spectrum according to claim 1, wherein in the step 2, the step of calibrating the calibration matrix of the current on-chip spectrometer specifically involves the following process:
inputting multiple known spectra to the current on-chip spectrometer, and measuring an output spectrum; calculating the calibration matrix of the current on-chip spectrometer according to the multiple known spectra and the corresponding output spectra.

4. The reconstruction method for multi-input spectrum according to claim 1, wherein in the step 4, constructing an optimization target for a k-th spectrum under test, and performing optimization iteration on the k-th spectrum under test according to a constructed optimization target, so that a reconstructed spectrum corresponding to the k-th spectrum under test is obtained after the optimization target is minimized, a formula of the optimization target for the k-th spectrum under test is specifically as follows:
$${\hat{s}}_{M \times 1 , k} = {min}_{{S}_{M \times 1 , k} , {S}_{M \times 1 , k} \geq 0} \{ {‖ {O}_{N \times 1} - {\sum }_{k = 1}^{k = K} {α}_{1 , k} \cdot {A}_{N \times M , k} \cdot {S}_{M \times 1 , k} ‖}^{2} + {\sum }_{k = 1}^{k = K} {α}_{2 , k} \vert \vert {S}_{M \times 1 , k} {\vert \vert}_{1} + {\sum }_{k = 1}^{k = K} {α}_{3 , k} \vert \vert D ( {S}_{M \times 1 , k} ) {\vert \vert}_{2}^{2} \}$$
in the formula, Ŝ_{M×1,k} is the reconstructed spectrum, O_{N×1} are the detection spectra, D( ) represents a differential operation, K is a quantity of the spectra under test, α_{1,k}, α_{2,k} and α_{3,k} are a first weight to a third weight respectively; A_{N×M,k} is the calibration matrix of the k-th spectrum under test, S_{M×1,k} is the k-th spectrum under test, ∥ ∥₂ is a L2 norm; and ∥ ∥₁ is a L1 norm.

5. The reconstruction method for multi-input spectrum according to claim 1, wherein the thermal light tunable components comprise electrodes.

6. The reconstruction method for multi-input spectrum according to claim 2, wherein the precision of the reconstructed spectrum is specifically a relative reconstruction error εᵣ, and a calculation formula is as follows:
$${ε}_{r} = \frac{\vert \vert {S}_{M \times 1 , k} - {\hat{S}}_{M \times 1 , k} {\vert \vert}_{2}}{\vert \vert {S}_{M \times 1 , k} {\vert \vert}_{2}}$$
in the formula, S_{M×1,k} is the k-th spectrum under test, Ŝ_{M×1,k} is the reconstructed spectrum, and ∥ ∥₂ is a L2 norm.

7. The reconstruction method for multi-input spectrum according to claim 1, wherein a quantity of input waveguides of the on-chip spectrometer is greater than or equal to a quantity of the spectra under test.

8. A computational reconstruction on-chip spectrometer for multispectral parallel detection, comprising an on-chip spectrometer comprising thermal light tunable components, a spectrometer calibration module, and a spectral optimization reconstruction module;
the spectrometer calibration module, configured to randomly activate the thermal light tunable components and obtain a calibration matrix of a spectrometer in an activated state;
the on-chip spectrometer comprising the thermal light tunable components, configured to generate detection spectra corresponding to multiple spectra under test;
the spectral optimization reconstruction module, configured to reconstruct the multiple spectra under test according to the calibration matrix and the detection spectra to obtain a reconstructed spectrum.

9. The computational reconstruction on-chip spectrometer for multispectral parallel detection according to claim 8, wherein the computational reconstruction on-chip spectrometer further comprises a spectral precision optimization module, wherein the spectral precision optimization module is configured to calculate a precision of the reconstructed spectrum and optimize the reconstructed spectrum.
